(19) United States
(12) Patent Application Publication
(10) Pub. No.: US 2018/0130018 A1
(43) Pub. Date: May 10, 2018

(54) SYSTEM AND METHOD FOR PROTECTING INFORMATION FOR ENHANCED LIFE CYCLE SUPPORT AND DISASTER RECOVERY OF INDUSTRIAL PROCESS CONTROL AND AUTOMATION SYSTEMS

(71) Applicant: Honeywell International Inc., Morris Plains, NJ (US)

(72) Inventors: Shreehari Sreenivasamurthy, Bangalore (IN); Bhaskar Shetty, Bangalore (IN); Amol Gandhi, Bangalore (IN)

(21) Appl. No.: 15/346,903

(22) Filed: Nov. 9, 2016

(51) Int. Cl. G06Q 10/10; G06Q 50/18; G06F 11/14; G06F 17/30

(52) U.S. Cl. CPC G06Q 10/10; G06F 17/30011; G06F 11/1446; G06Q 50/184

(57) ABSTRACT

A method includes allocating a cloud-based information repository to a customer. The information repository is hosted by a vendor and includes a plurality of compartments. The compartments include first, second, and third compartments, and each compartment has a different level of access. The information repository is accessible to the customer over a network connection. The method also includes receiving one or more first documents from the customer and saving the one or more first documents in the information repository. The method further includes receiving a request from the customer for a report associated with the information repository. In addition, the method includes generating the report and sending the report to the customer. The method could also include storing at least one second document in the information repository, where the at least one second document is associated with a life-cycle of a customer product.

### TECHNICAL FIELD

This disclosure relates generally to industrial process control and automation systems. More specifically, this disclosure relates to a system and method for protecting information for enhanced life cycle support and disaster recovery of industrial process control and automation systems.

### BACKGROUND

Industrial process control and automation systems are often used to automate large and complex industrial processes. These types of systems routinely include various components including sensors, actuators, and controllers. The controllers typically receive measurements from the sensors and generate control signals for the actuators.

End customers and suppliers of industrial process control and automation system components (also referred to as automation vendors) often work closely together from the start of a project until a plant is operational. This is typically done in order to initiate and maintain continuous operations that run in an efficient and productive manner. This relationship can continue from the start of the plant until the end of life of the plant in order to maintain safe and secure plant operations, which can span a lengthy period of time.

### SUMMARY

This disclosure provides a system and method for protecting information for enhanced life cycle support and disaster recovery of industrial process control and automation systems.

In a first embodiment, a method includes allocating a cloud-based information repository to a customer. The information repository is hosted by a vendor and includes a plurality of compartments. The compartments include a first compartment, a second compartment, and a third compartment, and each compartment has a different level of access. The information repository is accessible to the customer over a network connection. The method also includes receiving one or more first documents from the customer and saving the one or more first documents in the information repository. The method further includes receiving a request from the customer for a report associated with the information repository. In addition, the method includes generating the report and sending the report to the customer.

In a second embodiment, an apparatus includes at least one memory and at least one processor. The at least one memory is configured to store a cloud-based information repository for a customer. The information repository is hosted by a vendor and includes a plurality of compartments. The compartments include a first compartment, a second compartment, and a third compartment, and each compartment has a different level of access. The information repository is accessible to the customer over a network connection. The at least one processing device is configured to allocate the information repository to the customer. The at least one processing device is also configured to receive one or more first documents from the customer and save the one or more first documents in the information repository. The at least one processing device is further configured to receive a request from the customer for a report associated with the information repository. In addition, the at least one processing device is configured to generate the report and send the report to the customer.

In a third embodiment, a non-transitory computer readable medium contains instructions that, when executed by at least one processing device, cause the at least one processing device to allocate a cloud-based information repository to a customer. The information repository is hosted by a vendor and includes a plurality of compartments. The compartments include a first compartment, a second compartment, and a third compartment, and each compartment has a different level of access. The information repository is accessible to the customer over a network connection. The medium also contains instructions that, when executed by the at least one processing device, cause the at least one processing device to receive one or more first documents from the customer and save the one or more first documents in the information repository. The medium further contains instructions that, when executed by the at least one processing device, cause the at least one processing device to receive a request from the customer for a report associated with the information repository. In addition, the medium contains instructions that, when executed by the at least one processing device, cause the at least one processing device to generate the report and send the report to the customer.

Other technical features may be readily apparent to one skilled in the art from the following figures, descriptions, and claims.

### BRIEF DESCRIPTION OF THE DRAWINGS

For a more complete understanding of this disclosure, reference is now made to the following description, taken in conjunction with the accompanying drawings, in which:

FIG. 1 illustrates an example industrial process control and automation system according to this disclosure;

FIG. 2 illustrates an example system that uses a cloud-based information repository according to this disclosure;

FIG. 3 illustrates an example of an information repository in the system of FIG. 2 according to this disclosure;

FIG. 4 illustrates an example method for protecting customer information related to an industrial process control and automation system according to this disclosure; and

FIG. 5 illustrates an example device for performing functions associated with protecting customer information related to an industrial process control and automation system according to this disclosure.

### DETAILED DESCRIPTION

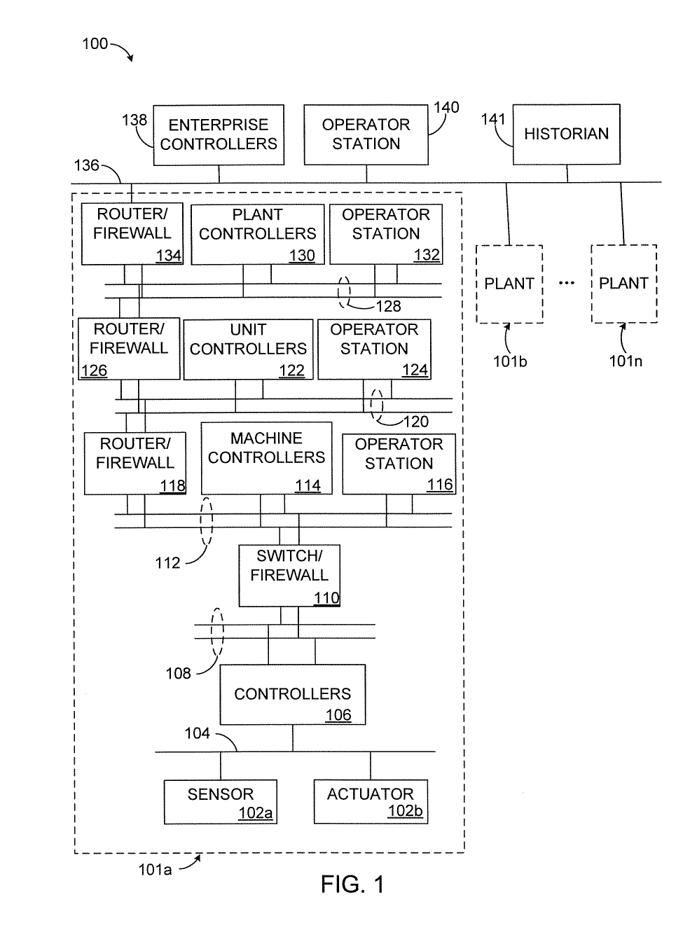

FIGS. 1 through 5, discussed below, and the various embodiments used to describe the principles of the present invention in this patent document are by way of illustration only and should not be construed in any way to limit the scope of the invention. Those skilled in the art will understand that the principles of the invention may be implemented in any type of suitably arranged device or system.

FIG. 1 illustrates an example industrial process control and automation system 100 according to this disclosure. As shown in FIG. 1, the system 100 includes various components that facilitate production or processing of at least one product or other material. For instance, the system 100 is used here to facilitate control over components in one or multiple plants 101a-101n. Each plant 101a-101n represents one or more processing facilities (or one or more portions thereof), such as one or more manufacturing facilities for producing at least one product or other material. In general, each plant 101a-101n may implement one or more processes and can individually or collectively be referred to as a process system. A process system generally represents any system or portion thereof configured to process one or more products or other materials in some manner.

In FIG. 1, the system 100 is implemented using the Purdue model of process control. In the Purdue model, “Level 0” may include one or more sensors 102a and one or more actuators 102b. The sensors 102a and actuators 102b represent components in a process system that may perform any of a wide variety of functions. For example, the sensors 102a could measure a wide variety of characteristics in the process system, such as temperature, pressure, or flow rate. Also, the actuators 102b could alter a wide variety of characteristics in the process system. The sensors 102a and actuators 102b could represent any other or additional components in any suitable process system. Each of the sensors 102a includes any suitable structure for measuring one or more characteristics in a process system. Each of the actuators 102b includes any suitable structure for operating on or affecting one or more conditions in a process system.

At least one network 104 is coupled to the sensors 102a and actuators 102b. The network 104 facilitates interaction with the sensors 102a and actuators 102b. For example, the network 104 could transport measurement data from the sensors 102a and provide control signals to the actuators 102b. The network 104 could represent any suitable network or combination of networks. As particular examples, the network 104 could represent an Ethernet network, an electrical signal network (such as a HART or FOUNDATION FIELDBUS network), a pneumatic control signal network, or any other or additional type(s) of network(s).

In the Purdue model, “Level 1” may include one or more controllers 106, which are coupled to the network 104. Among other things, each controller 106 may use the measurements from one or more sensors 102a to control the operation of one or more actuators 102b. For example, a controller 106 could receive measurement data from one or more sensors 102a and use the measurement data to generate control signals for one or more actuators 102b. Multiple controllers 106 could also operate in redundant configurations, such as when one controller 106 operates as a primary controller while another controller 106 operates as a backup controller (which synchronizes with the primary controller and can take over for the primary controller in the event of a fault with the primary controller). Each controller 106 includes any suitable structure for interacting with one or more sensors 102a and controlling one or more actuators 102b. Each controller 106 could, for example, represent a multivariable controller, such as a Robust Multivariable Predictive Control Technology (RMPCT) controller or other type of controller implementing model predictive control (MPC) or other advanced predictive control (APC). As a particular example, each controller 106 could represent a computing device running a real-time operating system.

Two networks 108 are coupled to the controllers 106. The networks 108 facilitate interaction with the controllers 106, such as by transporting data to and from the controllers 106. The networks 108 could represent any suitable networks or combination of networks. As particular examples, the networks 108 could represent a pair of Ethernet networks or a redundant pair of Ethernet networks, such as a FAULT TOLERANT ETHERNET (FTE) network from HONEYWELL INTERNATIONAL INC.

At least one switch/firewall 110 couples the networks 108 to two networks 112. The switch/firewall 110 may transport traffic from one network to another. The switch/firewall 110 may also block traffic on one network from reaching another network. The switch/firewall 110 includes any suitable structure for providing communication between networks, such as a HONEYWELL CONTROL FIREWALL (CF9) device. The networks 112 could represent any suitable networks, such as a pair of Ethernet networks or an FTE network.

In the Purdue model, “Level 2” may include one or more machine-level controllers 114 coupled to the networks 112. The machine-level controllers 114 perform various functions to support the operation and control of the controllers 106, sensors 102a, and actuators 102b, which could be associated with a particular piece of industrial equipment (such as a boiler or other machine). For example, the machine-level controllers 114 could log information collected or generated by the controllers 106, such as measurement data from the sensors 102a or control signals for the actuators 102b. The machine-level controllers 114 could also execute applications that control the operation of the controllers 106, thereby controlling the operation of the actuators 102b. In addition, the machine-level controllers 114 could provide secure access to the controllers 106. Each of the machine-level controllers 114 includes any suitable structure for providing access to, control of, or operations related to a machine or other individual piece of equipment. Each of the machine-level controllers 114 could, for example, represent a server computing device running a MICROSOFT WINDOWS operating system. Although not shown, different machine-level controllers 114 could be used to control different pieces of equipment in a process system (where each piece of equipment is associated with one or more controllers 106, sensors 102a, and actuators 102b).

One or more operator stations 116 are coupled to the networks 112. The operator stations 116 represent computing or communication devices providing user access to the machine-level controllers 114, which could then provide user access to the controllers 106 (and possibly the sensors 102a and actuators 102b). As particular examples, the operator stations 116 could allow users to review the operational history of the sensors 102a and actuators 102b using information collected by the controllers 106 and/or the machine-level controllers 114. The operator stations 116 could also allow the users to adjust the operation of the sensors 102a, actuators 102b, controllers 106, or machine-level controllers 114. In addition, the operator stations 116 could receive and display warnings, alerts, or other messages or displays generated by the controllers 106 or the machine-level controllers 114. Each of the operator stations 116 includes any suitable structure for supporting user access and control of one or more components in the system 100. Each of the operator stations 116 could, for example, represent a computing device running a MICROSOFT WINDOWS operating system.

At least one router/firewall 118 couples the networks 112 to two networks 120. The router/firewall 118 includes any suitable structure for providing communication between networks, such as a secure router or combination router/firewall. The networks 120 could represent any suitable networks, such as a pair of Ethernet networks or an FTE network.

In the Purdue model, “Level 3” may include one or more unit-level controllers 122 coupled to the networks 120. Each unit-level controller 122 is typically associated with a unit in a process system, which represents a collection of different machines operating together to implement at least part of a process. The unit-level controllers 122 perform various functions to support the operation and control of components in the lower levels. For example, the unit-level controllers 122 could log information collected or generated by the components in the lower levels, execute applications that control the components in the lower levels, and provide secure access to the components in the lower levels. Each of the unit-level controllers 122 includes any suitable structure for providing access to, control of, or operations related to one or more machines or other pieces of equipment in a process unit. Each of the unit-level controllers 122 could, for example, represent a server computing device running a MICROSOFT WINDOWS operating system. Additionally or alternatively, each controller 122 could represent a multivariable controller, such as a HONEYWELL C300 controller. Although not shown, different unit-level controllers 122 could be used to control different units in a process system (where each unit is associated with one or more machine-level controllers 114, controllers 106, sensors 102a, and actuators 102b).

Access to the unit-level controllers 122 may be provided by one or more operator stations 124. Each of the operator stations 124 includes any suitable structure for supporting user access and control of one or more components in the system 100. Each of the operator stations 124 could, for example, represent a computing device running a MICROSOFT WINDOWS operating system.

At least one router/firewall 126 couples the networks 120 to two networks 128. The router/firewall 126 includes any suitable structure for providing communication between networks, such as a secure router or combination router/firewall. The networks 128 could represent any suitable networks, such as a pair of Ethernet networks or an FTE network.

In the Purdue model, “Level 4” may include one or more plant-level controllers 130 coupled to the networks 128. Each plant-level controller 130 is typically associated with one of the plants 101a-101n, which may include one or more process units that implement the same, similar, or different processes. The plant-level controllers 130 perform various functions to support the operation and control of components in the lower levels. As particular examples, the plant-level controller 130 could execute one or more manufacturing execution system (MES) applications, scheduling applications, or other or additional plant or process control applications. Each of the plant-level controllers 130 includes any suitable structure for providing access to, control of, or operations related to one or more process units in a process plant. Each of the plant-level controllers 130 could, for example, represent a server computing device running a MICROSOFT WINDOWS operating system.

Access to the plant-level controllers 130 may be provided by one or more operator stations 132. Each of the operator stations 132 includes any suitable structure for supporting user access and control of one or more components in the system 100. Each of the operator stations 132 could, for example, represent a computing device running a MICROSOFT WINDOWS operating system.

At least one router/firewall 134 couples the networks 128 to one or more networks 136. The router/firewall 134 includes any suitable structure for providing communication between networks, such as a secure router or combination router/firewall. The network 136 could represent any suitable network, such as an enterprise-wide Ethernet or other network or all or a portion of a larger network (such as the Internet).

In the Purdue model, “Level 5” may include one or more enterprise-level controllers 138 coupled to the network 136. Each enterprise-level controller 138 is typically able to perform planning operations for multiple plants 101a-101n and to control various aspects of the plants 101a-101n. The enterprise-level controllers 138 can also perform various functions to support the operation and control of components in the plants 101a-101n. As particular examples, the enterprise-level controller 138 could execute one or more order processing applications, enterprise resource planning (ERP) applications, advanced planning and scheduling (APS) applications, or any other or additional enterprise control applications. Each of the enterprise-level controllers 138 includes any suitable structure for providing access to, control of, or operations related to the control of one or more plants. Each of the enterprise-level controllers 138 could, for example, represent a server computing device running a MICROSOFT WINDOWS operating system. In this document, the term “enterprise” refers to an organization having one or more plants or other processing facilities to be managed. Note that if a single plant 101a is to be managed, the functionality of the enterprise-level controller 138 could be incorporated into the plant-level controller 130.

Access to the enterprise-level controllers 138 may be provided by one or more operator stations 140. Each of the operator stations 140 includes any suitable structure for supporting user access and control of one or more components in the system 100. Each of the operator stations 140 could, for example, represent a computing device running a MICROSOFT WINDOWS operating system.

Various levels of the Purdue model can include other components, such as one or more databases. The database(s) associated with each level could store any suitable information associated with that level or one or more other levels of the system 100. For example, a historian 141 can be coupled to the network 136. The historian 141 could represent a component that stores various information about the system 100. The historian 141 could, for instance, store information used during production scheduling and optimization. The historian 141 represents any suitable structure for storing and facilitating retrieval of information. Although shown as a single centralized component coupled to the network 136, the historian 141 could be located elsewhere in the system 100, or multiple historians could be distributed in different locations in the system 100.

In particular embodiments, the various controllers and operator stations in FIG. 1 may represent computing devices. For example, each of the controllers and operator stations could include one or more processing devices and one or more memories for storing instructions and data used, generated, or collected by the processing device(s). Each of the controllers and operator stations could also include at least one network interface, such as one or more Ethernet interfaces or wireless transceivers.

As described in more detail below, various components in the system 100 could be designed or modified to operate in conjunction with a cloud-based information repository that supports secure protection of intellectual property and other information for life cycle support and disaster recovery of the system 100. For example, one or more of the operator stations 116, 124, 132, 140 or the historian 141 could be configured to communicate with, receive information from, or send information to a cloud-based information repository over one or more secure communication channels.

Although FIG. 1 illustrates one example of an industrial process control and automation system 100, various changes may be made to FIG. 1. For example, the system 100 could include any number of sensors, actuators, controllers, servers, operator stations, networks, and other components. Also, the makeup and arrangement of the system 100 in FIG. 1 is for illustration only. Components could be added, omitted, combined, or placed in any other suitable configuration according to particular needs. Further, particular functions have been described as being performed by particular components of the system 100. This is for illustration only. In general, control and automation systems are highly configurable and can be configured in any suitable manner according to particular needs. In addition, FIG. 1 illustrates one example operational environment that could operate in conjunction with a cloud-based information repository used for life cycle support and disaster recovery. This functionality can be used in any other suitable system, and the system need not be related to industrial process control and automation.

As discussed above, in industrial process control and automation systems, end customer and automation vendors (such as HONEYWELL INTERNATIONAL INC.) often work closely together from the start of a project until a plant is operational in order to initiate and maintain continuous operations that run in an efficient and productive manner. This relationship can continue from the start of the plant until the end of life of the plant in order to maintain safe and secure plant operations.

Every industrial plant tends to be unique in terms of its automation system configuration. The overall process control strategy, configuration information, project databases, and other related information (such as piping and instrumentation diagrams (P&IDs) and standards-related build documents) for a plant represents important intellectual property for an end customer.

Traditional approaches to maintaining and storing an end customer's intellectual property over a long period has several limitations and challenges. For example, there is typically a lack of safe, secure, and reliable infrastructure for maintaining intellectual property materials for the duration of a control system, which may be 20 to 30 years or even longer. Current mechanisms for maintaining physical assets, such as DVDs, software, audit reports, configuration details, and other engineering details, are not foolproof. As another example, there is often a substantial cost and effort associated with Front End Engineering & Design (FEED) activities once control equipment reaches end-of-life. Finally, there are few efficient mechanisms for end customers and automation vendors to share and exchange data due to multiple technical and logistical issues.

Automation vendors also often face multiple challenges when working with end customers. One challenge is that essentially every automation and control system may require upgrading at some point to maintain safe and reliable operations and leverage newer technologies. For example, it is estimated that approximately $65 billion worth of control systems are currently obsolete and due for migration. A significant amount of FEED is needed to address this obsolescence, and efficient infrastructure is needed to accommodate the FEED. Another challenge is developing and distributing relevant and up-to-date information associated with migration projects. This increases the risk of problems or failures for migration projects. In addition, it can be a challenge for an automation vendor to simply provide control system services and support, such as deploying critical patches, hot fixes, anti-virus updates, fixing customer-specific issues, and the like. Each of these can incur significant costs, effort, and logistical issues.

To address these or other issues, embodiments of this disclosure provide a cloud-based, dedicated information repository. The repository is operated and managed by an automation vendor and allows end customers (also referred to simply as “customers”) of the automation vendor to maintain and store intellectual property information or other valuable information.

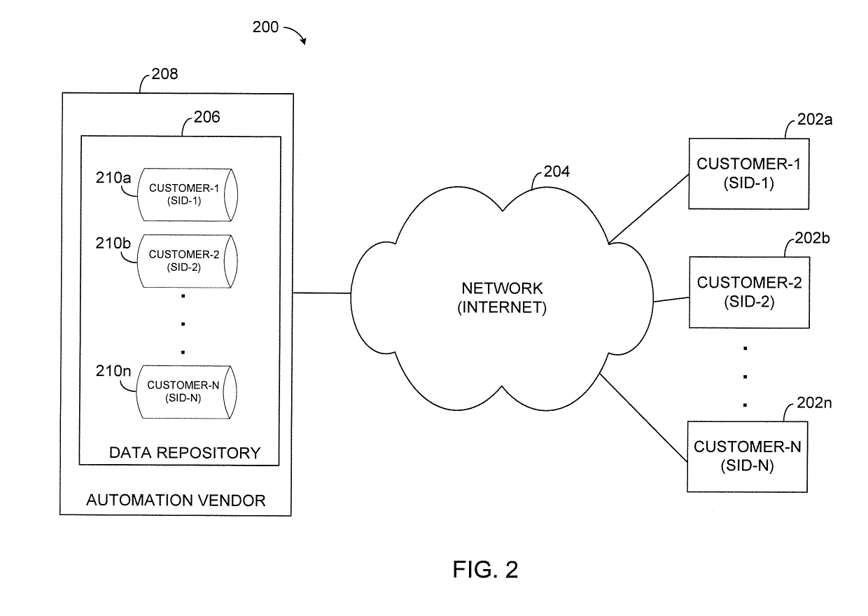

FIG. 2 illustrates an example system 200 that uses a cloud-based information repository according to this disclosure. For ease of explanation, the system 200 may be described as being used by end customers who operate industrial process control and automation systems, such as the system 100 of FIG. 1. However, the system 200 can be used with any other suitable system or device.

As shown in FIG. 2, the system 200 includes multiple customers 202a-202n (collectively referred to as customers 202), a network 204, a data repository 206, and an automation vendor 208. Each of the customers 202 represents a different customer of the automation vendor 208. In general, each customer 202 is typically a corporate or business entity that is unrelated to (and may be competitive with) other customers 202. However, multiple customers 202 may represent different plants or different business units within the same corporate or business entity. For example, large multi-national or other companies may have multiple divisions, where different divisions each have a relationship with an automation vendor. In such cases, each division may represent one customer 202. Each customer 202 is typically associated with information and components of one or more process control and automation systems. Each customer 202 has or is associated with a system identifier (SID) that identifies the particular customer 202 within the system 200.

The customers 202 access and receive information from and send information to the data repository over the network 204. The network 204 represents any suitable communication network or networks, such as one or more local area networks, wide area networks, or global networks such as the Internet.

The data repository 206 is a centralized data repository that is managed, owned, or otherwise hosted by the automation vendor 208 and that stores intellectual property information or other important information for the customers 202. The data repository 206 is a cloud-based data repository to the customers 202 because each customer 202 accesses the data repository 206 over the network 204 and the data repository 206 operates “in the cloud.” A computing cloud generally refers to a collection of servers or other computing devices, where processing, data storage, and other tasks are performed by the computing devices and the specific computing devices that perform the tasks can vary over time as demands change. The data repository 206 includes any suitable structure(s) for storing and retrieving information in a cloud-based environment.

In this example, the data repository 206 includes multiple information repositories 210a-210n (collectively referred to as information repositories 210). Each information repository 210 is associated with one of the customers 202. For example, the information repository 210a could be associated with the customer 202a, the information repository 210b could be associated with the customer 202b, and so on. Each information repository 210 stores intellectual property information or other information only for the corresponding customer 202. Each information repository 210 includes any suitable structure(s) for storing information related to a particular customer.

The data repository 206 is configured such that each customer 202 can only access its corresponding information repository 210. Access to an information repository 210 by its corresponding customer 202 can be secured by any suitable authentication process. For example, a customer user may have to provide a unique username and password in order to access that customer's information repository 210. In some embodiments, the customer 202 can access the information repository 210 via a user interface, such as a web browser-enabled interface, on a computing device. The user interface allows the customer 202 to receive information from or send information to the information repository 210.

Although FIG. 2 illustrates one example of a system 200 that uses a cloud-based information repository, various changes may be made to FIG. 2. For example, the system 200 could support any number of customers, networks, vendors, and data repositories. Also, while described as having a one-to-one relationship between the customers 202 and the information repositories 210, the system 200 could support other relationships between the customers 202 and the information repositories 210. Further, the arrangement of components shown in FIG. 2 is for illustration only. Components could be added, omitted, combined, or placed in any other suitable configuration according to particular needs. In addition, FIG. 2 illustrates one example environment in which a cloud-based information repository can be supported. This functionality can be used in any other suitable device or system, and the device or system need not be related to industrial process control and automation.

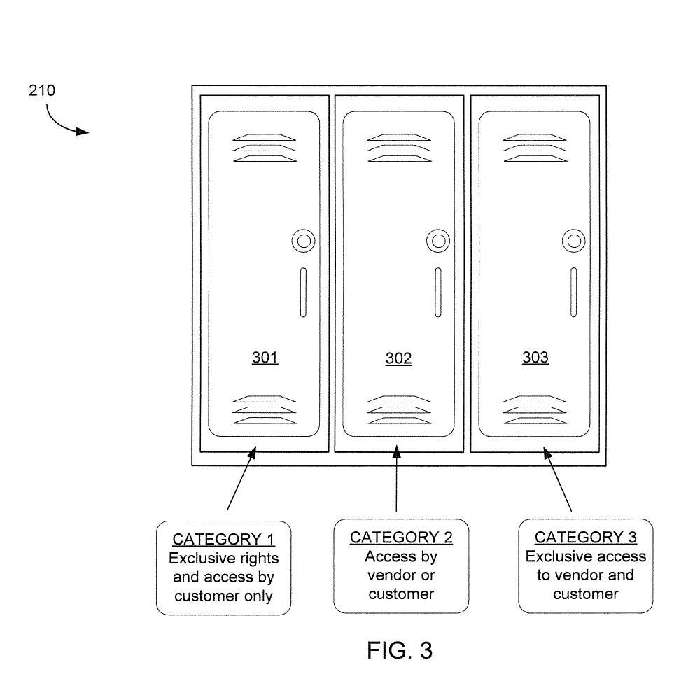

FIG. 3 illustrates an example of an information repository 210 in the system 200 of FIG. 2 according to this disclosure. As shown in FIG. 3, each information repository 210 can be visualized as a digital “locker” having three compartments 301-303. Each compartment 301-303 provides a different level of access and privacy for the customer 202 and the automation vendor 208.

The first compartment 301 is configured for use by the customer 202 only. That is, only the customer 202 can access and utilize the first compartment 301 of the information repository 210. Access to the first compartment 301 by the automation vendor 208 is restricted. The restricted access can take various forms, such as when the automation vendor 208 has no access to the first compartment 301 or only has access in the event of an emergency. Because the first compartment 301 has limited access, it can be used to store sensitive or important intellectual property materials or other information, such as P&IDs, control system configuration documents, standards-related build documents, and the like, for a long term (such as twenty years or more).

The second compartment 302 is configured for use by the customer 202 and the automation vendor 208. For example, both the customer 202 and the automation vendor 208 can access the second compartment 302 at any point in time. In some embodiments, the second compartment 302 can be used for a “Request-Service” model between the customer 202 and the automation vendor 208 or vice-versa, such as when the customer 202 can place requests for service and relevant request-related information into the second compartment 302 and the automation vendor 208 can place service-related information into the second compartment 302. As particular examples, the second compartment 302 could be used to store information such as non-disclosure agreements (NDAs), software patches and hot fixes, release management information, marketing information, service details, or any other information that may need to be transacted.

The third compartment 303 is configured to be accessed jointly by the customer 202 and the automation vendor 208. That is, both the customer 202 and the automation vendor 208 have to operate together (either simultaneously or in sync with each other) to access materials in the third compartment 303. In some embodiments, the rules and parameters regarding access to the third compartment 303 can be predefined based on a business model of the automation vendor 208 or a service level agreement (SLA) between the automation vendor 208 and the customer 202. For example, the automation vendor 208 may have posted a system solution to a particular problem in the third compartment 303, and the customer 202 may have license to access the solution only at predetermined times or only a limited number of times within a specified timeframe. In particular embodiments, the automation vendor 208 actively monitors the third compartment 303 to determine attempts by the customer 202 to access the third compartment 303. Such time-bound licenses can be facilitated by use of the information repository 210, and there is no need to physically deploy such a license.

Information stored in each information repository 210 can be backed up automatically according to a data backup and recovery scheme. Backed up data can be recovered from the information repository 210 in the event of a disaster or other problem where data or documents are lost. In some embodiments, the data backup and recovery scheme can be managed and performed by the automation vendor 208, while some details of the data backup and recovery scheme can be managed or modified by the customer 202. For example, the customer 202 could exclude certain documents or categories from backup. As another example, the customer 202 can schedule certain important documents to be backed up more frequently than other information. As a further example, the customer 202 can initiate a manual backup of information. Any suitable data backup, recovery, or redundancy scheme can be used for the information repositories 210.

The data repository 206 can also be used for life cycle support of process control and automation system-related information. For example, the automation vendor 208 may provide support for process control and automation products and systems during a life cycle. As a particular example, regular control and automation system component firmware upgrades can be made available to each customer 202 by posting the upgrade information in the customer information repositories 210. When the automation vendor 208 determines the end-of-life for a product, the automation vendor 208 can reduce support over time and then ultimately terminate support. Each customer 202 can have varying access to documents in the associated information repository 210 based on the current level of support in the life cycle. For instance, near the end of a product life cycle, a customer may have very limited access to product support documents in the information repository 210. Each customer 202 can connect to the information repository 210 and review a support timeline for a product in the information repository 210. In addition, up-to-date reports can be generated by the customer 202 via the information repository 210 at any point in time.

The data repository 206 could further be utilized for a Software as a Service (SaaS) model for faster service and better customer satisfaction. SaaS is a software licensing and delivery model in which software is licensed on a subscription basis and is centrally hosted. Also, activities associated with antivirus scanning reports and validation and verification reports related to operating system security patches can be scheduled and maintained using the data repository 206. In general, a wide variety of documents and data can be exchanged between the automation vendor 208 and the customers 202 without significant logistical overhead for either the automation vendor 208 or the customers 202.

In addition, the data repository 206 may include a number of transactional logging features that help track transactions and trends of interactions between the customers 202 and the automation vendor 208. For example, the data repository 206 can archive important communications between the automation vendor 208 and the customers 202. As a particular example, the data repository can capture minutes of meetings (MOMs) (such as action items, open issues, resolved issues, decisions, and agreements made between the parties) based on these communications between the automation vendor 208 and the customers 202 and archive the MOMs digitally.

Activities and operations associated with the data repository 206 can be facilitated by the presence of an NDA between the automation vendor 208 and each customer 202. A NDA can address the relationship and trust between each customer 202 and the automation vendor 208 to share and maintain information in the data repository 206 in a secure manner. In some embodiments, the NDA can indicate or address the overall life for a given cluster associated with a functional area of a plant. As used here, a cluster is associated with an SID and refers to a functional area of a plant and its physical components (such as controllers, actuators, sensors, valves, tanks, and the like). For example, in a petrochemical plant, chemical processing and chemical storage may represent two different clusters. In accordance with the NDA, a customer 202 can request and receive a report detailing the current state of the cluster (such as whether a cluster is in current support, extended support, or contract support). This helps customers 202 manage and plan their operations in more efficient ways. For instance, customers 202 can estimate capital expenditures and operating expenditures more accurately.

Although FIG. 3 illustrates one example of an information repository 210 in the system 200 of FIG. 2, various changes may be made to FIG. 3. For example, each of the compartments 301-303 could be used to store any suitable information. Also, the information repository 210 could include a different number of compartments as needed or desired.

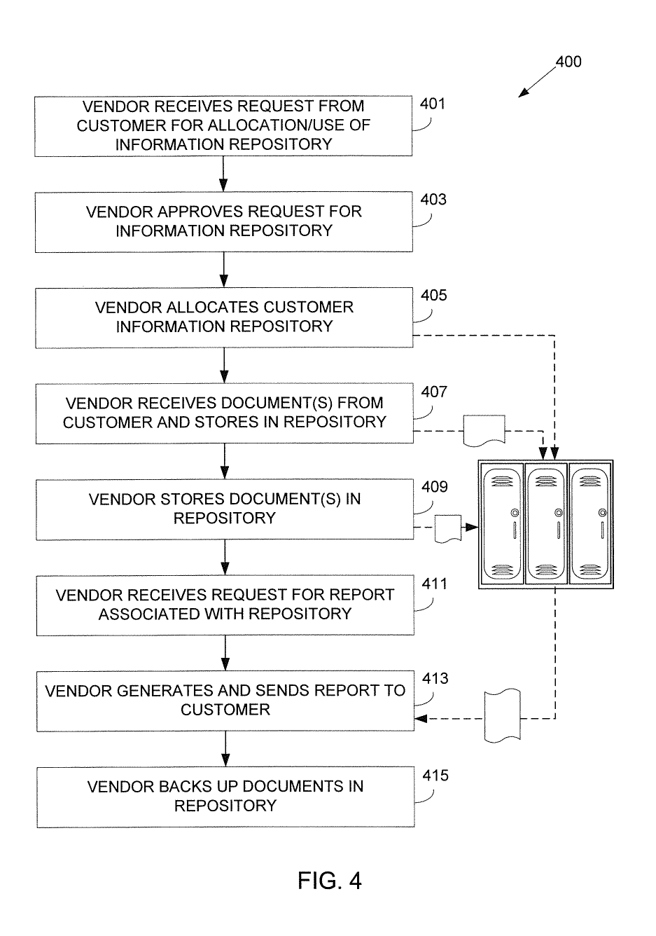

FIG. 4 illustrates an example method 400 for protecting customer information related to an industrial process control and automation system according to this disclosure. For ease of explanation, the method 400 is described as being performed using the system 200 of FIG. 2. However, the method 400 could be used with any suitable device or system.

At step 401, a vendor receives a request from a customer for allocation and use of a cloud-based information repository. This could include, for example, the automation vendor 208 receiving a request from a customer 202 for allocation and use of an information repository 210. The information repository is hosted by the vendor and includes multiple compartments, such as a first compartment, a second compartment, and a third compartment as described above. Each compartment has a different level of access. The information repository is accessible to the customer over a network connection.

At step 403, the vendor approves the request for the allocation and use of the information repository. This could include, for example, the automation vendor 208 approving the request from the customer 202. At step 405, the vendor allocates the information repository to the customer. This could include, for example, the automation vendor 208 allocating the information repository 210 to the customer 202 within the data repository 206.

At step 407, the vendor receives one or more first documents from the customer and saves the one or more first documents in the information repository. This could include, for example, the automation vendor 208 receiving one or more documents from the customer 202 and saving the documents in the information repository 210. At step 409, the vendor stores at least one second document in the information repository. This could include, for example, the automation vendor 208 storing at least one document in the information repository 210, where the at least one document is associated with a life-cycle of a customer product.

At step 411, the vendor receives a request from the customer for a report associated with the information repository. This could include, for example, the automation vendor 208 receiving a request from the customer 202 for a report associated with the information repository 210. At step 413, the vendor generates the report and sends the report to the customer. This could include, for example, the automation vendor 208 generating and sending the report to the customer 202

At step 415, the vendor automatically backs up the documents in the repository according to a predetermined backup scheme. This could include, for example, the automation vendor 208 backing up the documents in the information repository 210 according to a predetermined backup scheme.

Although FIG. 4 illustrates one example of a method 400 for protecting customer information related to an industrial process control and automation system, various changes may be made to FIG. 4. For example, while shown as a series of steps, various steps shown in FIG. 4 could overlap, occur in parallel, occur in a different order, or occur multiple times. Moreover, some steps could be combined or removed and additional steps could be added according to particular needs. In addition, while the method 400 is described with respect to the system 200 (which itself was described with respect to one or more industrial process control and automation systems), the method 400 may be used in conjunction with other types of devices and systems.

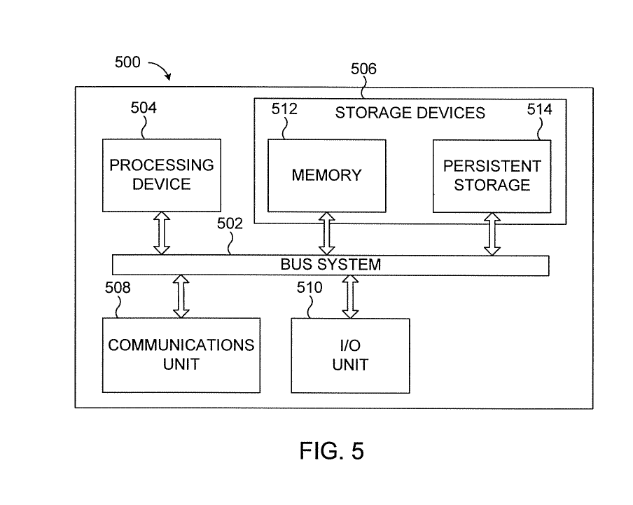

FIG. 5 illustrates an example device 500 for performing functions associated with protecting customer information related to an industrial process control and automation system according to this disclosure. The device 500 could, for example, represent a computing device in the system 200 of FIG. 2, such as a computing device associated with the customers 202 or the data repository 206. As another example, the device 500 could represent one of the operator stations 116, 124, 132, 140 or the historian 141 of FIG. 1. The device 500 could represent any other suitable device for performing functions associated with a cloud-based information repository.

As shown in FIG. 5, the device 500 can include a bus system 502, which supports communication between at least one processing device 504, at least one storage device 506, at least one communications unit 508, and at least one input/output (I/O) unit 510. The processing device 504 executes instructions that may be loaded into a memory 512. The processing device 504 may include any suitable number(s) and type(s) of processors or other devices in any suitable arrangement. Example types of processing devices 504 include microprocessors, microcontrollers, digital signal processors, field programmable gate arrays, application specific integrated circuits, and discrete circuitry.

The memory 512 and a persistent storage 514 are examples of storage devices 506, which represent any structure(s) capable of storing and facilitating retrieval of information (such as data, program code, and/or other suitable information on a temporary or permanent basis). The memory 512 may represent a random access memory or any other suitable volatile or non-volatile storage device(s). The persistent storage 514 may contain one or more components or devices supporting longer-term storage of data, such as a ready only memory, hard drive, Flash memory, or optical disc. In accordance with this disclosure, the memory 512 and the persistent storage 514 may be configured to store instructions associated with marking and detecting messages that have previously transited network devices.

The communications unit 508 supports communications with other systems, devices, or networks, such as the networks 101-103. For example, the communications unit 508 could include a network interface that facilitates communications over at least one Ethernet network, LCN, or ELCN. The communications unit 508 could also include a wireless transceiver facilitating communications over at least one wireless network. The communications unit 508 may support communications through any suitable physical or wireless communication link(s).

The I/O unit 510 allows for input and output of data. For example, the I/O unit 510 may provide a connection for user input through a keyboard, mouse, keypad, touchscreen, or other suitable input device. The I/O unit 510 may also send output to a display, printer, or other suitable output device.

Although FIG. 5 illustrates one example of a device 500 for performing functions associated with protecting customer information related to an industrial process control and automation system, various changes may be made to FIG. 5. For example, various components in FIG. 5 could be combined, further subdivided, or omitted and additional components could be added according to particular needs. Also, computing devices can come in a wide variety of configurations, and FIG. 5 does not limit this disclosure to any particular configuration of device.

The embodiments disclosed above provide a number of advantageous benefits to automation customers. For example, customers can safely and securely save intellectual property or other important information, which otherwise would represent significant overhead to maintain and manage, over a long period of time. Problems such as loss of data due to theft or unintentional usage can be reduced. Customer information can be retrieved almost any time, whenever needed or desired. In addition, if intellectual property or other information is stored properly using the disclosed embodiments, customers may save money by minimizing FEED logistical efforts in the future when a system becomes old and due for migration.

The disclosed embodiments also provide a number of advantageous benefits to automation vendors. For example, the disclosed embodiments significantly reduce product release logistics and other overheads over current approaches, where significant effort may be spent in deployment and release mechanisms (such as burning CDs, shipping, and the like). Also, the disclosed embodiments can promote a better relationship with the vendor's customers by reducing the customers' FEED efforts and providing up-to-date customer details at any time.

In some embodiments, various functions described in this patent document are implemented or supported by a computer program that is formed from computer readable program code and that is embodied in a computer readable medium. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc, a digital video disc, or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, e.g., a rewritable optical disc or an erasable memory device.

It may be advantageous to set forth definitions of certain words and phrases used throughout this patent document. The terms “application” and “program” refer to one or more computer programs, software components, sets of instructions, procedures, functions, objects, classes, instances, related data, or a portion thereof adapted for implementation in a suitable computer code (including source code, object code, or executable code). The term “communicate,” as well as derivatives thereof, encompasses both direct and indirect communication. The terms “include” and “comprise,” as well as derivatives thereof, mean inclusion without limitation. The term “or” is inclusive, meaning and/or. The phrase “associated with,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, have a relationship to or with, or the like. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

The description in the present application should not be read as implying that any particular element, step, or function is an essential or critical element that must be included in the claim scope. The scope of patented subject matter is defined only by the allowed claims. Moreover, none of the claims is intended to invoke 35 U.S.C. § 112(f) with respect to any of the appended claims or claim elements unless the exact words “means for” or “step for” are explicitly used in the particular claim, followed by a participle phrase identifying a function. Use of terms such as (but not limited to) “mechanism,” “module,” “device,” “unit,” “component,” “element,” “member,” “apparatus,” “machine,” “system,” “processor,” or “controller” within a claim is understood and intended to refer to structures known to those skilled in the relevant art, as further modified or enhanced by the features of the claims themselves, and is not intended to invoke 35 U.S.C. § 112(f).

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A method comprising:
allocating a cloud-based information repository to a customer, the information repository hosted by a vendor and comprising a plurality of compartments, the compartments comprising a first compartment, a second compartment, and a third compartment, each compartment having a different level of access, the information repository accessible to the customer over a network connection;
receiving one or more first documents from the customer and saving the one or more first documents in the information repository;
receiving a request from the customer for a report associated with the information repository; and
generating the report and sending the report to the customer.

2. The method of claim 1, further comprising:
receiving a request from the customer for allocation and use of the cloud-based information repository; and
approving the request for the allocation and use of the information repository.

3. The method of claim 1, wherein:
the first compartment is configured to be accessed and maintained by the customer only;
the second compartment is configured to be accessed by the customer and the vendor at any time; and
the third compartment is configured to be accessed jointly by the customer and the vendor and is accessible to the customer only at predetermined times.

4. The method of claim 1, wherein:
the first compartment is configured to store intellectual property of the customer, the intellectual property including at least one of: piping and instrumentation diagrams (P&IDs), control system configuration documents, and standards-related build documents;
the second compartment is configured to store at least one of: non-disclosure agreements (NDAs), software patches and hot fixes, and release management information; and
the third compartment is configured to store information that is distributable according to a time-bound license.

5. The method of claim 1, wherein the information repository is accessible by the customer via a web browser.

6. The method of claim 1, further comprising:
storing at least one second document in the information repository, the at least one second document associated with a life-cycle of a customer product.

7. The method of claim 6, further comprising:
automatically backing up the one or more first documents and the at least one second document according to a predetermined backup scheme.

8. An apparatus comprising:
at least one memory configured to store a cloud-based information repository for a customer, the information repository hosted by a vendor and comprising a plurality of compartments, the compartments comprising a first compartment, a second compartment, and a third compartment, each compartment having a different level of access, the information repository accessible to the customer over a network connection; and
at least one processing device is configured to:
allocate the information repository to the customer;
receive one or more first documents from the customer and save the one or more first documents in the information repository;
receive a request from the customer for a report associated with the information repository; and
generate the report and send the report to the customer.

9. The apparatus of claim 8, wherein the at least one processing device is further configured to:
receive a request from the customer for allocation and use of the cloud-based information repository; and
approve the request for the allocation and use of the information repository.

10. The apparatus of claim 20, wherein:
the first compartment is configured to be accessed and maintained by the customer only;
the second compartment is configured to be accessed by the customer and the vendor at any time; and
the third compartment is configured to be accessed jointly by the customer and the vendor and is accessible to the customer only at predetermined times.

11. The apparatus of claim 8, wherein:
the first compartment is configured to store intellectual property of the customer, the intellectual property including at least one of: piping and instrumentation diagrams (P&IDs), control system configuration documents, and standards-related build documents;
the second compartment is configured to store at least one of: non-disclosure agreements (NDAs), software patches and hot fixes, and release management information; and
the third compartment is configured to store information that is distributable according to a time-bound license.

12. The apparatus of claim 8, wherein the at least one processing device is configured to provide a web-based interface to the information repository.

13. The apparatus of claim 8, wherein the at least one processing device is further configured to store at least one second document in the information repository, the at least one second document associated with a life-cycle of a customer product.

14. The apparatus of claim 13, wherein the at least one processing device is further configured to automatically back up the one or more first documents and the at least one second document according to a predetermined backup scheme.

15. A non-transitory computer readable medium containing instructions that, when executed by at least one processing device, cause the at least one processing device to:
allocate a cloud-based information repository to a customer, the information repository hosted by a vendor and comprising a plurality of compartments, the compartments comprising a first compartment, a second compartment, and a third compartment, each compartment having a different level of access, the information repository accessible to the customer over a network connection;
receive one or more first documents from the customer and save the one or more first documents in the information repository;
receive a request from the customer for a report associated with the information repository; and
generate the report and send the report to the customer.

16. The non-transitory computer readable medium of claim 15, further containing instructions that, when executed by the at least one processing device, cause the at least one processing device to:
receive a request from the customer for allocation and use of the cloud-based information repository; and
approve the request for the allocation and use of the information repository.

17. The non-transitory computer readable medium of claim 15, wherein:
the first compartment is configured to be accessed and maintained by the customer only;
the second compartment is configured to be accessed by the customer and the vendor at any time; and
the third compartment is configured to be accessed jointly by the customer and the vendor and is accessible to the customer only at predetermined times.

18. The non-transitory computer readable medium of claim 15, wherein:
the first compartment is configured to store intellectual property of the customer, the intellectual property including at least one of: piping and instrumentation diagrams (P&IDs), control system configuration documents, and standards-related build documents;
the second compartment is configured to store at least one of: non-disclosure agreements (NDAs), software patches and hot fixes, and release management information; and
the third compartment is configured to store information that is distributable according to a time-bound license.

19. The non-transitory computer readable medium of claim 15, further containing instructions that, when executed by the at least one processing device, cause the at least one processing device to:
store at least one second document in the information repository, the at least one second document associated with a life-cycle of a customer product.

20. The non-transitory computer readable medium of claim 19, further containing instructions that, when executed by the at least one processing device, cause the at least one processing device to:
automatically back up the one or more first documents and the at least one second document according to a predetermined backup scheme.
